(19) United States
(12) Patent Application Publication
(10) Pub. No.: US 2012/0076938 A1
(43) Pub. Date: Mar. 29, 2012

(54) System and Method of Applying a Chrome-Like Coating on Objects

(76) Inventor: Isaac Ike Banoun, Pacific Palisades, CA (US)

(21) Appl. No.: 12/892,778

(22) Filed: Sep. 28, 2010

(51) Int. Cl. B05C 5/04; B05D 1/34; B05D 3/10

(52) U.S. Cl. 427/304; 118/315; 427/426

(57) ABSTRACT

This invention provides for a method, system and apparatus for applying a chrome-like coating on objects using hand-held, portable, and self-contained spray canisters. The chrome-like coating is achieved by the simultaneous spraying of the object's surface with an ammoniacal silver nitrate solution and a reducing agent. This simultaneous spraying may be done using two spray canisters, one holding the ammoniacal silver nitrate solution and the other holding the reducing agent, with one canister held in each hand. The simultaneous spraying may also be achieved using a new, single-trigger, hand-held, spray gun configured to hold two canisters which are activated simultaneously by the single trigger.

### BACKGROUND OF THE INVENTION

1. Field of the Invention

The invention relates, in general, to a system and method of applying a chrome-like coating on objects and more particularly, to a system and method of spraying objects with an ammoniacal silver nitrate spray and a reducing agent using multiple portable and self-contained spray canisters.

2. Related Art

There are many objects where a coating having a metallic, bright and reflective, chrome-like, surface is desired. These objects may be large and small, and may be made of plastic or metal, as well as many other materials, such as wood, glass, or ceramics. There are several methods of applying a thin film or coating on various objects that imparts a mirror-like or shiny, metallic appearance to the object sprayed. Generally, however, the method requires applying an ammoniacal silver nitrate solution and a second solution comprising an organic reducing agent, such as glucose, simultaneously onto the surface of the designated object.

In one method, as disclosed in U.S. Pat. No. 4,975,305 (incorporated herein by reference) issued Dec. 4, 1990 to Pier C. Biginelli, a primer layer of alkyd resin is first applied, followed by an acid aqueous solution comprising stannous chloride. After washing the surface of the object with water, the ammoniacal silver nitrate solution and the reducing agent are simultaneously sprayed onto the surface of the object.

There are numerous variations in the process of applying a chrome-like coating on objects. For example, U.S. Pat. No. 6,398,854 (incorporated herein by reference) issued Jun. 4, 2002 to Hidenori Aonuma, discloses a reducing agent that comprises a reducing solution and a strong base component, as well as an additive comprising a compound of polyvalent metal. Additionally, the process disclosed also includes pretreatment of the object with a hydrochloric acid acidified stannous chloride solution and then application of a first ammoniacal silver nitrate solution before bringing another ammoniacal silver nitrate solution into contact with a reducing solution on the surface of the object.

In the process of applying the chrome-like coating on an object, there may also be other steps included in the process. These may include pretreatment of the object, such as, for example, applying a primer coat, drying the object after application of a primer coat, applying an activator, and after the simultaneous application of the ammoniacal silver nitrate solution and the reducing agent, such as a reducing solution, applying a topcoat or clear coat to the object, as well as washing the object between applications. However, the common feature generally found in all methods and processes is the simultaneous application of an ammoniacal silver nitrate solution and an reducing solution to the surface of object being sprayed.

Generally, the process of applying a chrome-like coating, using silver nitrate, on objects utilizes spray guns connected to an air compressor and/or pressurized vessels holding the chemicals to be sprayed. This requires a power source for the compressor as well as hoses and tubing to apply the chemicals. Additionally, these industrial-caliber machines may require a paint booth having a large work area, and also drain ducts to drain any excess chemicals and other liquids into a collecting vessel. An example of such an apparatus is disclosed in U.S. Pat. No. 4,975,305 referred to above and incorporated by this reference herein.

Therefore, there exists a need for an improved system and method of applying a chrome-like coating to various objects that is portable and self-contained, and does not require large, heavy, industrial-caliber machines having multiple hoses, tubing, and containers. Such a system and method is one that can be used by both professional users and do-it-yourself-ers (“DIY's”), anywhere, safely and efficiently without a large work area.

### SUMMARY

In view of the above, a method and a system of applying a chrome-like coating on objects using hand-held, portable, and self-contained spray canisters is provided. An example implementation of a method includes applying a primer coating to the object, and then drying the primer coating. The object is then sprayed with an activator and washed with deionized water. Then the object is sprayed simultaneously with an ammoniacal silver nitrate solution and a reducing agent. This simultaneous spraying may be done using two spray canisters, one holding the ammoniacal silver nitrate solution and the other holding the reducing agent, with a canister held in each hand. The simultaneous spraying may also be done with a new single-trigger, hand-held, spraying apparatus configured to hold two canisters that are simultaneously activated by the single trigger. After this spraying is completed, the object may be again washed with water, and finally, a topcoat or clear coat may be applied to the object to create a durable seal, if desired.

In another aspect of the invention, an example of a system of applying a chrome-like coating on an object in accordance with the invention is provided. The system comprises a plurality of hand-held, portable, and self-contained spray canisters, together with the solutions, liquids, and coatings described in the paragraph above stored separately in sealed containers. To implement the method of applying a chrome-like coating on objects in accordance with the invention, the solutions, liquids, and coatings are poured into the appropriate canisters and applied in accordance with instructions corresponding to the type of metal or chemical spraying chosen.

Other compositions, systems, methods, features and advantages of the invention will be or will become apparent to one with skill in the art upon examination of the following figure(s) and detailed description. It is intended that all such additional compositions, methods, features and advantages be included within this description, be within the scope of the invention, and be protected by the accompanying claims.

### BRIEF DESCRIPTION OF THE FIGURES

The invention may be better understood by referring to the following figure(s). The components in the figures are not necessarily to scale, emphasis instead being placed upon illustrating the principles of the invention. In the figures, like reference numerals designate corresponding parts throughout the different views.

FIG. 1 shows a flow chart illustrating a method of applying a chrome-like coating on objects.

FIG. 2 shows an example implementation for carrying out step 110 of the process shown in FIG. 1, using two hands and two spraying canisters.

FIG. 3A shows a side view of an example implementation of a portable dispensing device for carrying out step 110 of the process shown in FIG. 1.

FIG. 3B shows a front view of the portable dispensing device shown in FIG. 3A.

FIG. 4A shows the typical coats applied to an object's surface after carrying out step 114 of the process shown in FIG. 1, using a powdercoating process.

FIG. 4B shows the typical coats applied to an object's surface after carrying out step 116 of the process shown in FIG. 1, using an infrared light process, or “IR curing.”

### DETAILED DESCRIPTION

In the following description, reference is made to the accompanying drawings and figures that form a part hereof, and which show, by way of illustration, specific preferred embodiments in which the invention may be practiced. Other examples of implementations may be utilized and certain changes may be made in the relative proportions of the components of the compositions described herein without departing from the scope of the present invention.

The objects subject to the chrome-like coat spraying in accordance with this invention can be of any material. Examples of such objects may be made of wood, any type of plastic, glass, ceramic, metal, gypsum, clay, stone, styrofoam, or any other material on which a shiny, mirror-like surface is desired. As stated above, there is a need and desire to be able to produce a chrome-like coating, especially on the surfaces of smaller objects, quickly and easily without the use of heavy, cumbersome, industrial-grade equipment, or harsh polluting chemicals used in traditional chroming applications such as, of course, Chromium (e.g., hexavalent/trivalent). In general, embodiments of the present invention relate to methods, systems, and devices that may be utilized in a process of applying a chrome-like coating on objects.

According to one implementation, a system in accordance with the present invention (which may be referred to as a chroming system), may comprise 6 spray gun kits, such as Preval® spray guns (canisters containing 6 different liquids utilized by the process as described below), an air blow can, an 8 oz. bottle containing the basecoat (a primer layer such as alkyd resin), a 4 oz. bottle containing the hardener, an 8 oz. bottle containing the top coat (a transparent coating or varnish of epoxy, polyurethane, acrylic or similar protectant), a bottle containing 16 ml of activator (acid water solution of stannous chloride), a bottle containing 4 ml of the ammoniacal silver nitrate solution, a bottle containing 4 ml of the reducing agent, such as a reducing solution, a gallon bottle filled with deionized water, 4 syringes, a pair of goggles, a mask, a pair of gloves, and an instruction and precautions manual. The 6 spray canisters mentioned above may be filled and refilled as follows: first canister contains the basecoat, second canister contains the activator, third canister contains the ammoniacal silver nitrate solution, fourth canister contains the reducing agent, fifth canister contains deionized water, and finally, sixth canister contains the top coat.

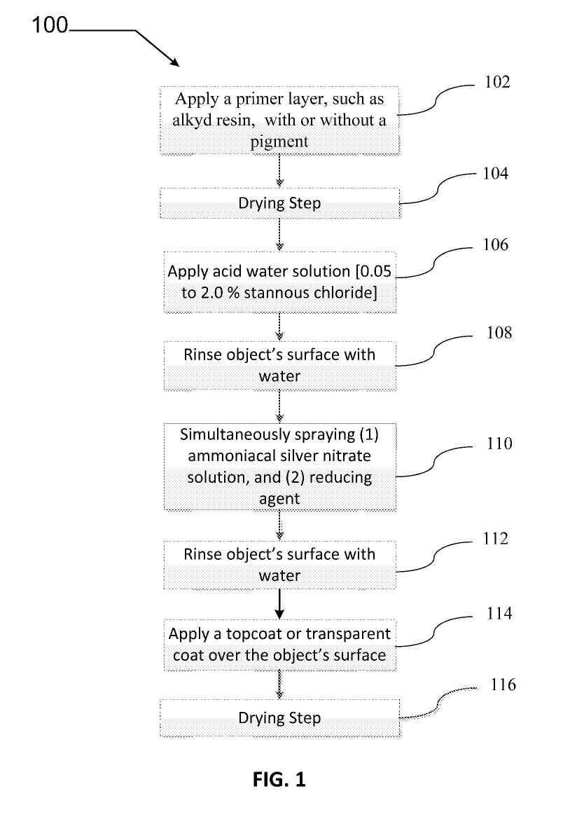

The process 100, shown in FIG. 1, is used to apply a chrome-like coat on objects. This process requires no machines or compressors. This process is designed for items of all size and shapes. This process may also be used to repair a hard chrome spot. As described below, this process may involve using refillable aerosol cans.

First, in step 102, an application of a primer layer such as alkyd resin to the object's surface takes place. This application of a basecoat results in a uniform object surface, which provides a very good supporting layer for the adhesion of the other layers applied later on in the process. This primer layer is applied by uniformly spreading this liquid product over the object's surface. This is preferably achieved by spraying in view of the more uniform distribution of the product that can be obtained this way. The alkyd resin is preferably applied as a solution in a suitable solvent such as toluene, xylene, methyl ketone, or ethyl acetate.

A pigment may be added to the solution to impart a desired colored base to the object. As an alkyd resin containing a pigment, a product marketed under trademark Centari 500 by DuPont de Nemours Co. may be used.

In step 104, the solution applied to the object may be dried, preferably either at room temperature for about 24 hours, or at 50° C. for about 2 hours.

Next, in step 106, a 0.05-2.0% by volume, acid water solution of stannous chloride is applied over the dried primer layer of alkyd resin as an agent to activate and speed up the reaction to reduce the sliver ions to metallic silver. This acid water solution is acidified utilizing concentrated hydrochloric acid up to a pH value between 1 and 2.

Next, step 108 provides for washing the treated object's surface with deionized water. In this step, distilled water may be also utilized. This step may be used to prevent deposition of impurities over the finish layer after applying the layers of steps 102 and 104.

In Step 110, the silver mirror imparting the metallic appearance is formed on the object's surface. This silver shine or mirror effect is achieved by reducing the silver ions, which may be achieved by a reaction known in analytic chemistry for the quantitative detection of alkheydes or aldoses and is also called the “Tollens Test.”

The Tollen's Test method may involve the preparation of a so-called Tollen's Reagent, that is, 0.5-3% by volume ammoniacal silver nitrate solution, wherein the silver is in the form of a ridiamine silver complex Ag(NH₃)₂+. To prepare this solution, a 5-30% by volume of ammoniacal silver nitrate solution must be basified by means of concentrated ammonium hydroxide until the salt has completely dissolved. The ammoniacal silver nitrate solution may then be added to a ten times larger volume of a water solution, which may comprise of 0.5M of ammonium hydroxide.

The Tollen's Test method also may also involve the preparation of a 1-5% by volume water solution of a reducing agent, preferably a 2% reducing sugar glucose solution. The reducing sugar solution may also be acidified by means of sulphuric acid, which has been found to improve the reaction.

A key phase of step 110 is the simultaneous mixing of the ammoniacal silver nitrate solution and the acid solution of the reducing sugar, right before or while being applied to the object's surface. In this phase, the aforementioned solutions may be mixed in air, immediately before being applied to the object's surface. The aforementioned solutions may also be mixed at the point of contact with the object's surface. The mixing of the solutions and applying them to the object's surface forms a silver mirror (the desired metallized chrome-like appearance). In this phase also, any color pigment, which may have been applied earlier in the process, will be covered by the sliver mirror.

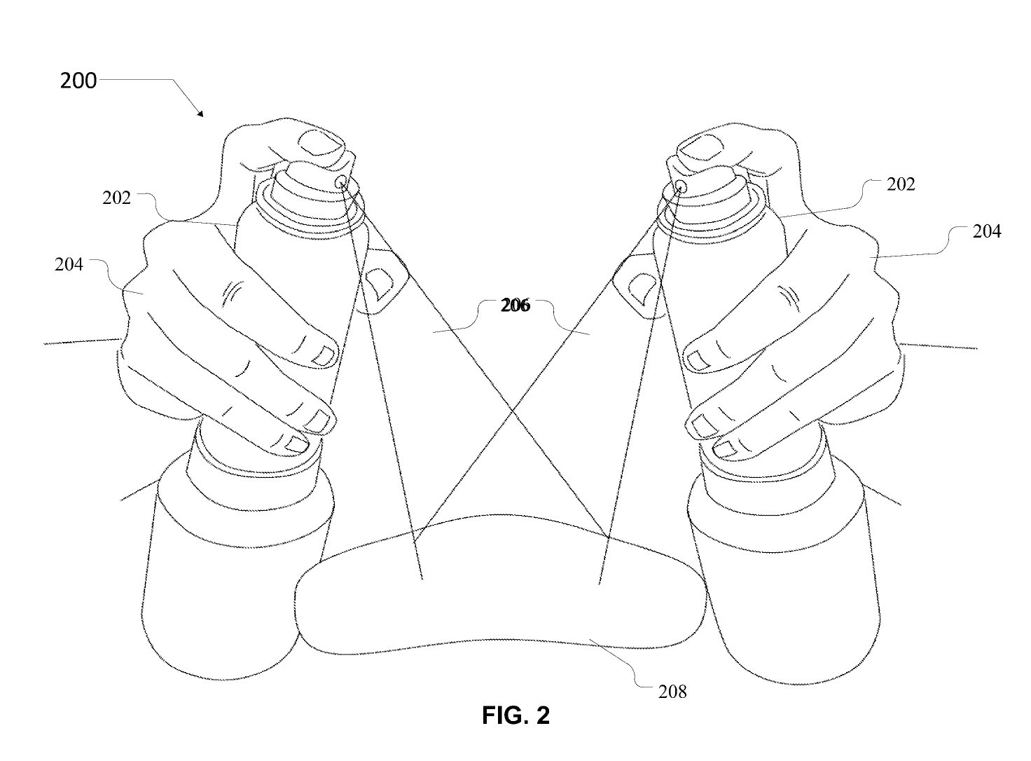

The aforementioned solutions in this step are preferably contained in separate containers, preferably aerosol spray cans. Alternatives to aerosol spray may also be used, such as atomization or any other method of dispensing a pressurized liquid. As shown in FIG. 2, the simultaneous application of the solutions may be achieved by holding one spray container 202 can in each hand 204, and spraying the solutions 206 at the same time on the object's surface 208, thereby conforming to the method of step 110 above. Another embodiment may involve the use of a single spray gun, handle or depressing device that attaches to two aerosol spray cans. The spray gun may have one trigger, the compression of which will cause the attached aerosol cans to dispense the contained solutions at the same time.

In step 112, the object's surface is washed with water to remove any possible excess of reagents that have not reacted.

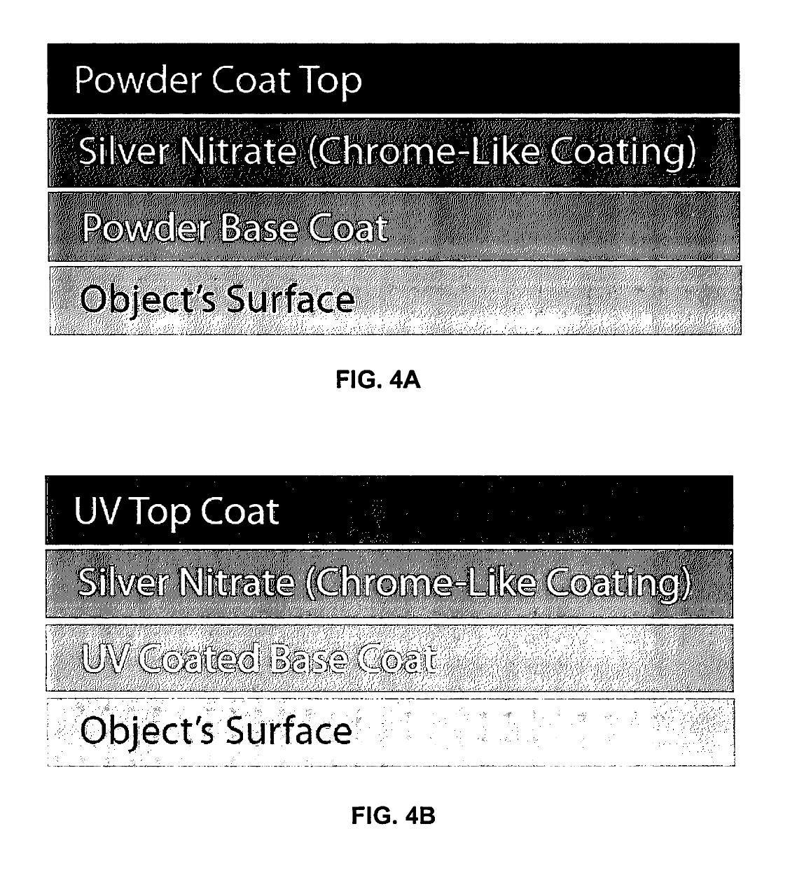

Step 114 involves the application of a transparent coating for the protection and stabilization of the metallizing layer on the object's surface. Varnish of the epoxy, polyurethane, acrylic or similar type of protection film may be applied over the object's surface. Powdercoating may also be used (as shown in FIG. 4A), as well as any ambient or thermal cure clearcoat.

Finally, in step 116, this varnish is dried at 50° C. for two hours or at room temperature (ambient cure) for 24 hours. Alternatively, drying may be accomplished by applying an ultraviolet light process, or a “UV curing” step, or an infrared light process, or a “IR curing” step (as shown in FIG. 4B).

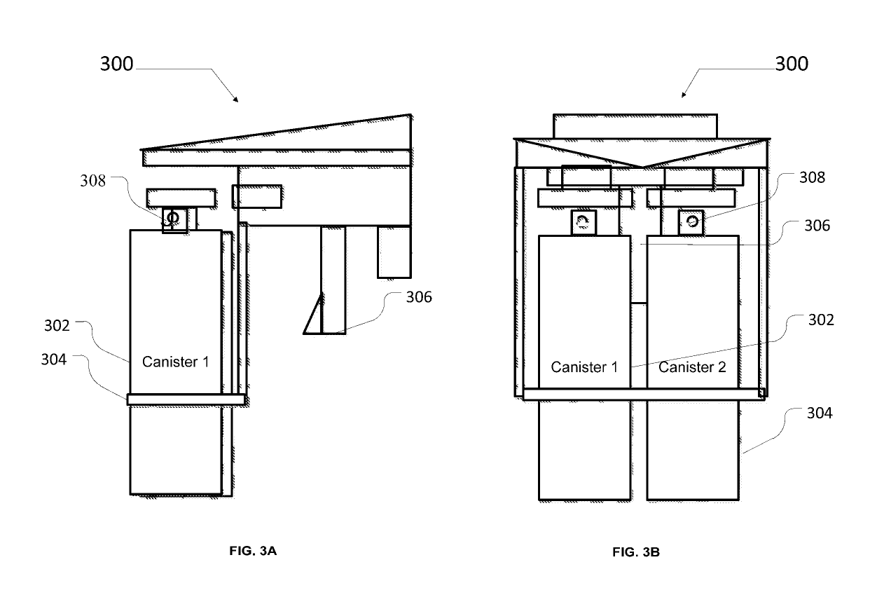

The system and method in this present invention may utilize a new double canister spray gun device 300, shown in FIG. 3A and FIG. 3B. This device will allow for the attachment of two spray canisters 302 and 304. The main function of this device is to spray the liquids contained in the attached canisters simultaneously. The device has a single trigger 306. The device is designed to allow the simultaneous spraying from the attached canisters when the device's trigger is pulled. In one embodiment of this device, the actuators 308 of the two spray canisters are adjusted to a position allowing for their contents to mix in midair when sprayed. The device may also have a lighting unit. The lighting unit may include a light bulb or similar object, capable to shed focused lighting to the targeted surface of the sprayed object.

The foregoing description of implementations of the present invention has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A method for applying a chrome-like coating, the method comprising the simultaneous spraying of an object with ammoniacal silver nitrate from a first portable, self-contained spray container, and a reducing agent from a second portable, self-contained spray container.

2. The method of claim 1, wherein at least one of the portable, self-contained spray containers is an aerosol canister.

3. The method of claim 2, wherein the aerosol canister is a Preval® spray canister.

4. The method of claim 1, wherein each of the portable, self-contained spray containers is an aerosol canister.

5. The method of claim 4, wherein each of the portable, self-contained spray canisters is contained within an single spray gun allowing the user to dispense the ammoniacal silver nitrate and reducing agent simultaneously.

6. The method of claim 4, wherein each of the portable, self-contained spray canisters is contained within a single spray gun allowing the user to dispense the ammoniacal silver nitrate solution and reducing agent solution simultaneously, using a single finger-trigger operatively connected to a dispensing actuator controlling each solution.

7. The method of claim 1, further including the steps, prior to said step of simultaneous spraying, of (a) applying a primer layer, (b) drying the object, (c) applying an activator solution, and (d) washing the object, and subsequent to said step of simultaneous spraying, of (e) washing the object, (f) applying a durable topcoat, and (g) drying the object.

8. The method of claim 7, wherein the activator solution of step (c) comprises a 0.05-2% by volume, acid water solution of stannous chloride.

9. The method of claim 8, wherein the ammoniacal silver nitrate comprises a 0.5-3% by volume, ammoniacal silver nitrate solution wherein the silver is a diamine silver complex Ag(NH₃)₂+.

10. The method of claim 9, wherein the reducing agent comprises a 2% glucose solution acidified via sulphuric acid.

11. The method of claim 10, wherein at least one of the washing steps (d) and (e) comprises washing the object with deionized or distilled water.

12. The method of claim 11, wherein each of the washing steps (d) and (e) comprises washing the object with deionized or distilled water.

13. The method of claim 11, wherein each of the washing steps (d) and (e) comprises washing the object with deionized water.

14. The method of claim 7, wherein the durable topcoat of step (f) comprises a powdercoat.

15. The method of claim 7, wherein the durable topcoat of step (f) comprises a UV-curable topcoat.

16. A system for applying a chrome-like coating on objects, the system comprising:
a primer layer applied to the object;
an activator solution applied to the object; and
an ammoniacal silver nitrate solution and a reducing agent applied separately but simultaneously to the object, in a manner allowing for the mixture of the solutions just prior to contacting the object's surface.

17. A spraying apparatus comprising:
at least one or more hand-triggers;
at least two or more dispensing actuators, each dispensing actuator being operatively connected to at least one of the hand-triggers; and
the one or more hand-triggers being capable of operating the dispensing actuators simultaneously.

18. The spraying apparatus of claim 17, further comprising at least two or more dispensing containers, each dispensing container being operatively connected to at least one of the dispensing actuators.

19. The spraying apparatus of claim 17, wherein the at least one or more hand-triggers comprises a single hand-trigger.

20. The spraying apparatus of claim 19, further comprising at least two or more dispensing containers, each dispensing container being operatively connected to at least one of the dispensing actuators.

21. The spraying apparatus of claim 17, further comprising at least one lighting unit capable of illuminating a sprayed object.

22. The spraying apparatus of claim 19, further comprising at least one lighting unit capable of illuminating a sprayed object.

23. The spraying apparatus of claim 20, further comprising at least one lighting unit capable of illuminating a sprayed object.
